(19) United States
(12) Patent Application Publication
(10) Pub. No.: US 2006/0015392 A1
(43) Pub. Date: Jan. 19, 2006

(54) Method and apparatus for ranking users according to evaluating providers of information

(76) Inventors: Surendranath Talla, Atlanta, GA (US); Andrew Franklin Robinson, Auckland (NZ)

Correspondence Address: YOUNG & THOMPSON, 745 SOUTH 23RD STREET, 2ND FLOOR, ARLINGTON, VA, 22202, US

(21) Appl. No.: 10/892,349

(22) Filed: Jul. 16, 2004

(51) Int. Cl. G06F 17/60

(52) U.S. Cl. 705/11

(57) ABSTRACT

A method and system for evaluating providers of information. The method comprises of the steps of allotting endorsement value points to such providers, allowing providers to transfer some or all of their endorsement value points to one or more other providers to enable that other provider or providers to increase their value as a provider. The system provides apparatus to run the method.

### FIELD OF INVENTION

The invention applies to any network, which ranks users according to their performance or expertise. FIG. 1 comprises a diagram of an “expertise network” which ranks users “high” to “low” based on their level of expertise.

### BACKGROUND

There are numerous information services provided to customers through electronic mediums such as the Internet. Most information services are either undertaken on a contractual basis where users pay a specified sum (typically before the service is performed), or the service is provided for free. Typically all users are considered equal and receive an equal standard of service from the information service.

In most situations information providers determine their own value and/or select their own prices. No system prior to the system disclosed in our U.S. Patent Specification 10/279,969 (the disclosure of which is included herein) automatically adjusts or determines the value of an information provider based upon interactions with the user in such a manner that takes into account the value of the user and the valve of the advisor, as determined by a centralised system.

That system provides incentives to information providers to provide higher quality of information at a faster turnaround rate.

We believe that our prior system is capable of improvement.

Such current expertise networks that rank users such as our own system rank those users based on points earned on the network. However, a rank based purely on points (say, earned through contributions such as for giving advice or answering questions) may not be a sufficient indicator of actual expertise since early adopters of the system have had time on their side to establish their high point values whereas newcomers with equivalent expertise do not have that advantage. In addition, some types of expert knowledge can only be judged by other experts of that field and without an opportunity for exhibiting their expertise, these potential experts may never be recognized.

By way of example consider a user who wants to join a computer network of movie reviewers. Suppose those movie reviewers are ranked according to their performance on the network e.g. those who have written the most reviews and received the highest ratings are ranked highest, and so forth. Now suppose the new user who wishes to join the network has been writing movie reviews for a well-known magazine for twenty years. How can the network recognize the user's talent and rank the user appropriately, without the user having to prove his talent by writing movie reviews for the new system?

On most networks, because the system knows nothing about the user, the user would need to start at the bottom of the ranking. This is disadvantageous.

### DEFINITION

Throughout this specification “information” and derivatives thereof means: information and content including, but not limited to text visual, audio and audio visual content provided through a communication systems including but not limited to computer networks or systems such as the Internet and telephony networks or systems.

“Information provider” includes any advisor, expert or service provider registered on the system.

### OBJECT

It is an object of the present invention to provide a method and/or apparatus for evaluating providers of information in a simple yet effective manner or which will at least, provide the public with a useful choice.

### STATEMENT OF INVENTION

Accordingly, in one aspect the invention consists in a method for evaluating providers of information, comprising the steps of allotting endorsement value points to such providers, allowing providers to transfer some or all of their endorsement value points to one or more other providers to enable that other provider or providers to increase their value as a provider.

Preferably the method further allots user value points to users, and endorsement value points transferred from a provider are added to the user value points of the receiver of the endorsement value points.

Preferably user value points are also received on the basis of information provided and a provider of endorsement value points to another provider is allotted a proportion of any user value points received by the provider who received the endorsement value points.

Preferably a new provider is allotted an initial quantity of user value points and endorsement value points.

Preferably a receiver of user value points in response to information provided is also allotted a number of endorsement value points.

In a further aspect the invention consists in a system for evaluating providers of information, comprising a programmed data processor, programmed to allot endorsement value points to providers of information, to allow providers to transfer some or all of their endorsement value points to one or more other providers, so as to enable that other provider or providers to increase their value as a provider.

Preferably the programme allots user value points and when endorsement value points are transferred from a provider the programme causes user value points to be added to the endorsement value points of the receiver of the endorsement value points.

Preferably the user value points are also alloted on basis of information provided and the provider of endorsement value points to another provider is allotted a proportion of any user value points received by the receiver of the endorsement value points.

Preferably a new provider is allotted an initial quantity of user value points and endorsement value points.

Preferably a receiver of user value points in response to information provided is also allotted a quantity of endorsement value points.

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

Our invention allows users on the network to increase their ranking by endorsing (or recognizing) the talents of other users as early as possible. And for users who have not earned their points to increase their ranking by attracting endorsements from established experts.

For the sake of explanation, let's associate a point's value to a user's ranking on the network. We'll call these User Value Points (UVP), so that the more UVP you have, the more highly ranked you are on the network. However, the final rank is not determined by just the UVP as we shall see later.

For each UVP, the invention assigns a selected number of points, which we can call Endorsement Value Points (EVP) to the user. For ease of explanation, we select this to be a one-to-one correspondence, although the ratio can be anything, So now, for every UVP you earn, you also earn an EVP.

The following example is also illustrated in FIG. 2.

Suppose Oscar has accumulated 1000 UVP, and therefore he has 1000 EVP. He decides to endorse Tina with 500 of his EVP. Oscar's UVP remains unchanged at 1000. But his EVP snow drops to 500.

Suppose Tina has: 250 UVP and 250 EVP (i.e. she has not endorsed anyone yet). With Oscar's endorsement, Tina has received what might be called “recognition”. For the sake of explanation, let's call these Recognition Points (RP). Tina has received 500 Recognition Points, which increase her Total User Value Points (TUVP). Keeping a one-to-one relationship, Tina's Total TUVP increases to 750.

Tina now has a TUVP of 750. Oscar has a TUVP of 1000.

This relationship involves the recognition of Tina by Oscar. Tina has earned 250 UVP and received 500 RP from Oscar. So 66% of her TUVP is recognition points (RP). Let's call that percentage the Recognition Value (RV).

If Oscar is the only one who has endorsed Tina, then for every X amount of UVP Tina earns, Oscar's RV would be a percentage of X (say, 66% in this case). So Oscar will earn a percentage times X of what Tina earns. In other words, his TUVP goes up as Tina's UVP goes up, at a percentage of what she earns. (Tina gets her full share of UVP and doesn't notice anything). Obviously, the relationship between Tina's RP and TUVP fluctuates over time, as she earns more UVP, or as more endorsements come in. So the system recalculates the RV periodically.

If Alan steps in and endorses Tina with 100 points, then the total RP for Tina is Oscar's 500+Alan's 100=600. Oscar receives a percentage (say, in this case, ⅚th) of the RV, and Alan receives a percentage (say, in this case, ⅙th).

Similarly Tina could endorse, say, Marianne, and Oscar and Alan could also receive RV on the RV points Tina receives from Marianne.

So the way to earn the most points through this invention is to recognize the talent of someone as early as possible. In this way, the invention allows a participant to receive endorsements and move up rankings without the participant having to demonstrate their talent through performance on the system itself.

As is typical of most systems, higher rank confers recognition and possibly other tangible benefits for the high ranked users. Hence this system allows participants to attract endorsements from top-ranked users so that they themselves can move up the ranks faster.

### BRIEF DESCRIPTION OF DRAWINGS

FIG. 1 shows a block diagram of a community of users of the method and apparatus of a preferred for of the inventor.

FIG. 2 shows an example transfer of points according to a preferred form of the invention.

FIG. 3 shows diagrammatically an endorsement relationship in a preferred method according to the invention.

FIG. 4 builds on FIG. 3

FIG. 5 is a flow diagram of an expertise management system, and

FIG. 6 is a flow diagram showing the implementation of the endorsement mechanism of the invention.

### DETAILED DESCRIPTION

A detailed description suitable for execution on a computer is provided for the purposes of illustration. Anyone with reasonable skill in the art will appreciate that the following description is set forth without any loss of generality or without imposing any limitations upon the claimed invention.

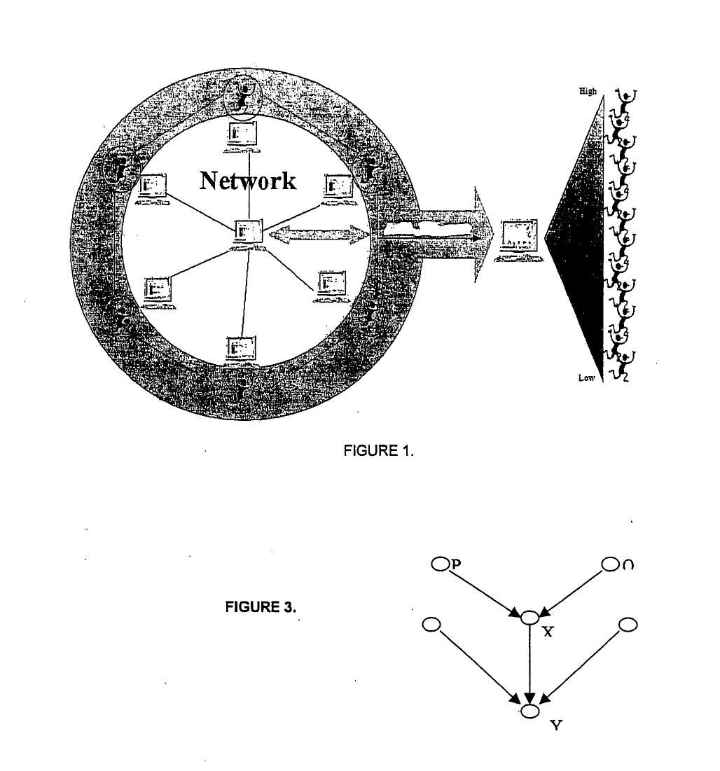

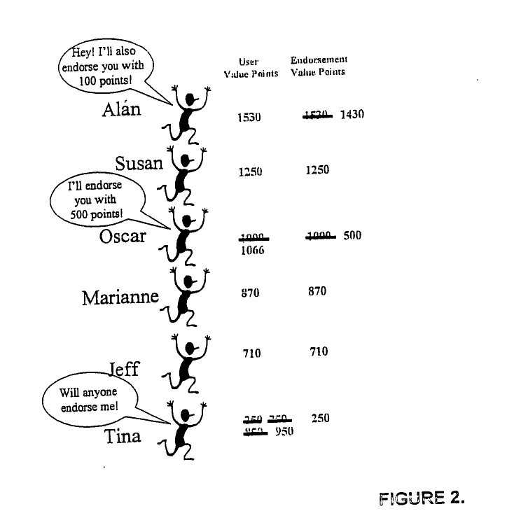

FIG. 1 illustrates a block diagram of a community of users interacting with each other over a computer network of programmable data processors (computer). Information pertaining to all the users and their activities is stored in a centralized database on the server S. Each user communicates wit the other users using a client program (such as a web browser) on their local computer indirectly through the server.

Let us assume that this community of users is comprised of computer experts who provide answers to other users who come seeking to solve their computer problems. Suppose that the experts earn points according to how many answers they have given and that the network rewards the top ranked experts.

If user X endorses user Y, we refer to X as the endorser and Y the endorsee. Corresponding to each user X, are associated the following attributes.

TUVP=Total User Value Points. All users are ranked based on their TUVP value.

UVP=User Value Points. These are the points earned by users for answering questions.

EVP=Endorsement Value Points. These are the points available for endorsing other users.

RP=Recognition Points received by the user through endorsements from other users.

EE=Endorsement Earnings. These are the points earned as a result of endorsee's eanrings,

Rank=Rank of the user. Rank is solely determined by TUVP; the higher the TUVP, the higher the rank. The user with highest TUVP has rank 1.

RP is the endorsement value received by user whereas; EE is the reward for recognizing experts. TUVP is given by the following equation:
TUVP=UVP+RP+EE

As in the example given at the beginning, here too we assume that users automatically earn one EVP for each UVP they earn. Though there need not be such an equitable relation between the two, nevertheless, we suggest that these two values be strongly correlated. By tying EVP to hard earned UVP, the users are encouraged to “invest” their EVP wisely. A wise investment is one in which their returns are maximized. This in turn implies that the endorsees are worth the recognition since the endorser's returns from the endorsements are intimately related to the endorsee's earnings potential.

From the definition of TUVP, it follows that the user can increase their rank by one or more of the following actions:

1. Contribute (answer queries in this example) and increase UVP.

2. Attract endorsements to increase RP.

3. Endorse other users so that the returns from their investments increase EE.

1. Increase UVP

This by definition involves the user in a more active role on the network. Based on which activities are valued by the network and the user's own contribution to them, the user may gain points. This is standard feature in most systems that provide some sort of expert help.

2. Increase RP

In order to increase RP, the user can make themselves more visible to potential endorsers by publishing a detailed profile which indicates their latent expertise areas and other additional information (proofs of their expertise from elsewhere) that attest to their expertise. The system itself can highlight potential experts by identifying those who have recently joined or who have been very active recently so that the endorsers can easily home in on their choices.

In addition, on each user's profile, the user could make any or all of the following public:

Level of endorsement sought (maximum-minimum amounts per endorsement)

Who are eligible to endorse me?

Amount of endorsements received

Returns for endorsers from me (with details)

Whom I endorsed

Returns from my endorsements (with details)

Past week's rank

This week's rank

These fields are not closed and, of course, other information could be supplied.

3. Increase EE

The user, with the help of the system, could identify potential experts early on when they join the network and endorse them. The sooner they endorse, the better the returns since their proportion of the endorsee earnings is directly proportional to the percentage of TUVP they have contributed as endorsements.

Now, since EVP (the amount they have that they can use towards endorsements) is limited, the user is expected to do some homework to identify the best candidates. This is key to locate the most promising candidates.

The returns from an endorsement (EE) can be computed in the following manner.

Let X (the endorser) endorses Y (the endorsee). The “endorsement relationship” can be represented as a directed graph EG, where the nodes of the graph represent users of the system like X, Y, etc., and a directed edge from node X to node Y represents an endorsement of Y by X (see FIG. 3).

Clearly, X should benefit from any increase in Y's UVP since that confirms his endorsement of Y's ability and should be rewarded in proportion to the amount of his endorsement. We would also like X to benefit from Y's own ability to identify and reward other experts through endorsements. Hence, to motivate X even further, any increases in Y's EE (represented as EE_{Y}) should also contribute towards X's EE (EE_{X}).

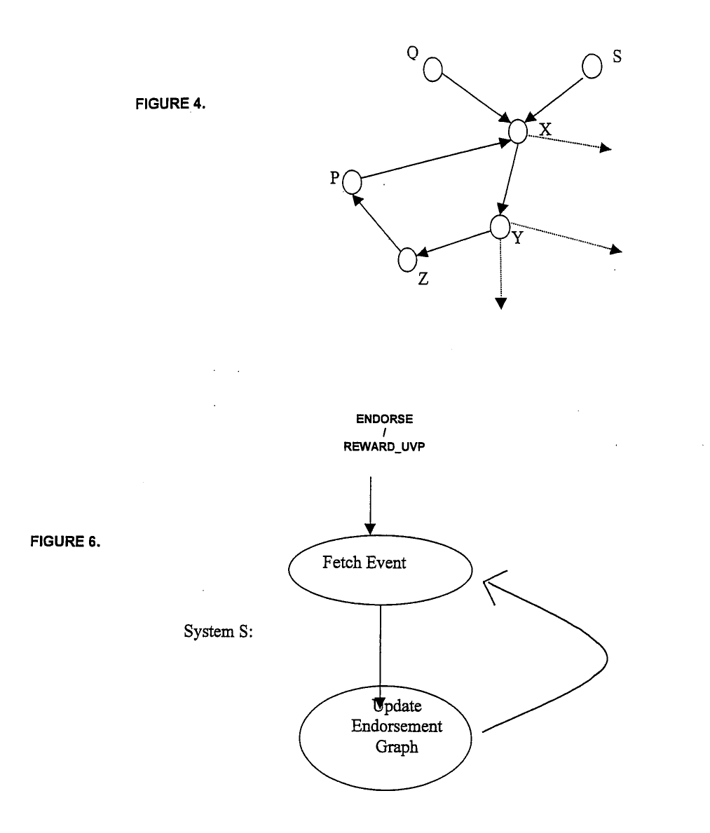

From the above description, it is clear that the reward function EE is defined recursively. This implies that if the system allows mutual endorsements (whether directly or indirectly) i.e., cycles within the endorsement graph, then the effect of EE_{Y} on EE_{X} can in turn affect EE_{Y} leading to a subsequent recomputation of EE_{X} if X and Y are on a cycle of the graph EG. The X-Y-Z-P cycle in FIG. 4 if EE_{Y} changes, it would trigger a change in EE_{X}, which in turn would affect EE_{P}, EE_{Z} and EE_{Y} again. This situation does not arise if the system prohibits Y from endorsing X if it is already endorsed by X (whether directly or indirectly) in other words by preventing cycles within EG. We consider the most general case where cyclic dependencies are allowed in the graph.

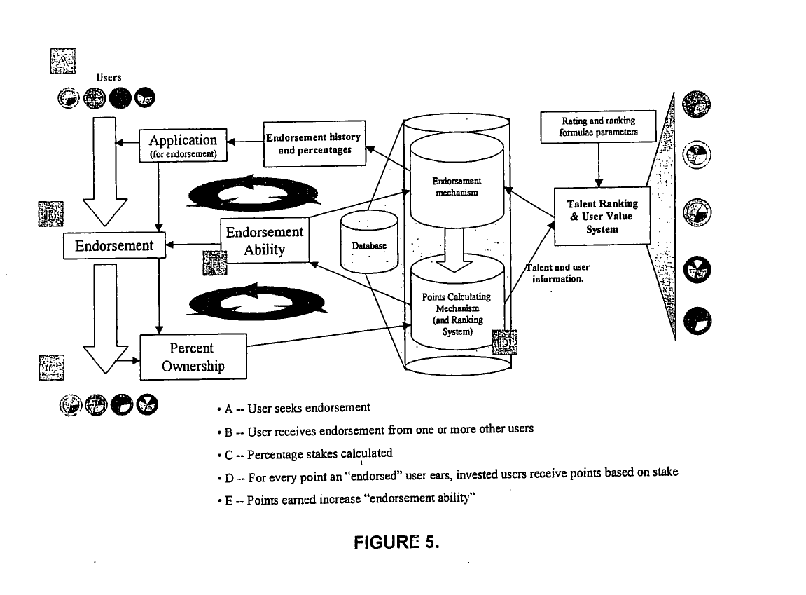

FIG. 5 is a flow diagram illustrating the operation of an expertise management system that incorporates the expert ranking mechanism as outlined in this innovation. Below we restrict our explanation to the endorsement mechanism only.

Let the nodule implementing the endorsement mechanism be called S. A high-level flow diagram showing the operation of S is shown in FIG. 6. S continually receives and processes in the same order the two events: ENDORSE and REWARD_UVP. The ENDORSE event would specify three parameters: X, Y and p where X is the endorser, Y the endorsee and p the number of points of endorsement value X contributes to Y. REWARD_UVP is an event indicating an increase in the user's UVP. It specifies two parameters: Y and d where Y is the user and d is the number of User Value Points earned by Y (say, due to tangible contributions to the system such as responding to a query which awards points for responses).

Let EG be the endorsement graph with N nodes and V edges, where each node i represents a user of the system and directed edges between nodes (say X and Y) represents “Y endorsed by X” relationship.

Also, let T, U, R, E and EVP be N×1 vectors such that,

T[i]=TUVP of member corresponding to node i

U[i]=UVP of member corresponding to node i

R[i]=Total amount endorsement points received by member corresponding to node i.

E[i]=EE of node member corresponding to node i

EVP[i]=Available endorsement value points for node i.

At all times, the following identity should hold:
T=U+R+E

We keep T[x]>0 by design (start each user with a base points).

Let D[X][Y]=1/T[X] when X=Y, X and Y being nodes in EG.

=0 otherwise.

RP[X][Y]=Total number of points given by X to Y as endorsements.

O[X][Y]=percentage of ownership of Y by X defined as RP[X][Y]/T[Y]

From the above, it follows that O=RP·D.

A high level algorithm to compute ENDORSE and REWARD_UVP are,

ENDORSE (X, Y, p)
{ EVP[X] = EVP[X] − p;

RP[X][Y] = RP[X][Y] + p;
O[X][Y] = (O[X][Y] * T[Y] + 100 * p) / (T[Y] + p);
for all (Z in ENDORSERS(Y))
{ O[Z][Y] = (O[Z][Y] * T[Y]) / T[Y] + p); } T[Y]
= T[Y] + p; }

REWARD_UVP(X, p)
{ // Let G be Nx1 matrix with all entries initialized to 0.

| // We can refer to G as the “gain” matrix. | |
|---|---|
| U[X] = U[X] + p; | |
| EVP[X] = EVP[X] + p; | |
| G[X] = p; | |
| while (∥ G ∥ > epsilon) | |
| { | T = T + G; |

for all (v in NODES (EG)) {D[v][v] = 1/T[v];}
E = E + G;
O = RP · D;
G = O · G; }}

The “+” and the “ ” in the while loop are standard matrix addition and multiplication operations respectively. The text following // on the same line is a comment. ∥G∥ is the row sum norm of G.

Intuitively, we can view each iteration of the “while loop” in the REWARD_UVP subroutine as causing the gains (represented by G) on each node to be proportionately distributed to all its endorsers. The loop terminates when the row sum norm of G is less than some predetermined constant epsilon. Epsilon and the ownership matrix O determine convergence of loop. If the maximum ownership factor allowed of any X in Y is always bounded by k (i.e., O[X][Y]<k, 0<k<1) ten it can easily shown that the REWARD_UVP routine will terminate in Ceiling(log(p/epsilon)/log(1/k)) iterations.

In practice, the above algorithm can be implemented more efficiently perhaps by even combining a contiguous sequence of REWARD_UV events into one single one.

A simple iterative algorithm for REWARD_UVP is given here for illusion purposes. Anyone skilled in the art can easily interpret it in his or her own favorite programming language.

SETUP_OWNERSHIP (node y)
{ T[y] = U[y] + R[y] + E[y];

forall (z in ENDORSERS(y)) { O[z][y] = RP[z][y] / T[y]; }}

REWARD_UVF(node y, float d)
{ U[y] = U[y] + d;

EVP[y] = EVP[y] + d;
T[y] = T[y] + d;
QUEUE Q = NULL;
INSERT_QUEUE(Q, [y,d]);
RECURSIVE_REWARD(Q);}

RECURSIVE_REWARD(Q)
[y,d] = POP_QUEUE(Q);

SETUP_OWNERSHIP(y);
forall (z in ENDORSERS(y))
{ gain = O(y,z) * d;

E[z] = E[z] + gain;
SETUP_OWNERSHIP(z);
if (gain > epsilon) {

INSERT_QUEUE(Q, [z,gain]);}} if (not ISEMPTY(Q))

RECURSIVE_REWARD(Q);}

Throughout the description and claims of is specification the word “comprise” and variations of that word, such as “comprises” and “comprising”, are not intended to exclude other additives, components, integers or steps.

What I claim is:

1. A method for evaluating providers of information, comprising the steps of allotting endorsement value points to such providers, allowing providers to transfer some or all of their endorsement value points to one or more other providers to enable that other provider or providers to increase their value as a provider.

2. A method as claimed in claim 1 wherein the method further allots user value points to users, and endorsement value points transferred from a provider are added to the user value points of the receiver of the endorsement value points.

3. A method as claimed in claim 2 wherein user value points are also received on the basis of information provided and a provider of endorsement value points to another provider is allotted a proportion of any user value points received by the provider who received the endorsement value points.

4. A method as claimed in claim 2 wherein a new provider is allotted an initial quantity of user value points and endorsement value points.

5. A method as claimed in claim 2 wherein a receiver of user value points in response to information provided is also allotted a number of endorsement value points.

6. A system for evaluating providers information, comprising a programmed data processor, programmed to allot endorsement value points to providers of information, to allow providers to transfer some or all of their endorsement value points to one or more other providers, so as to enable that other provider or providers to increase their value as a provider.

7. A system claimed in claim 7 wherein the programme allots user value points and when endorsement value points are transferred from a provider the programme causes user value points to be added to the endorsement value points of the receiver of the endorsement value points.

8. A system as claimed in claim 7 wherein the user value points are also allotted on basis of information provided and the provider of endorsement value points to another provider is allotted a proportion of any user value points received by the receiver of the endorsement value points.

9. A system as claimed in claim 7 wherein a new provider is allotted an initial quantity of user value points and endorsement value points.

10. A system as claimed in claim 7 wherein a receiver of user value points in response to information provided is also allotted a quantity of endorsement value points.
